(19) United States
(12) Patent Application Publication
(10) Pub. No.: US 2015/0124991 A1
(43) Pub. Date: May 7, 2015

(54) LIGHT EMITTING EARPHONE STRUCTURE

(71) Applicant: GREAT PERFORMANCE INDUSTRIES CO., LTD., NEW TAIPEI CITY (TW)

(72) Inventors: Jui-Bin HWAN, NEW TAIPEI CITY (TW); CALVIN SHIENING WANG, DIAMOND BAR, CA (US); Chin-Ming HSU, NEW TAIPEI CITY (TW)

(73) Assignee: GREAT PERFORMANCE INDUSTRIES CO., LTD., NEW TAIPEI CITY (TW)

(21) Appl. No.: 14/069,485

(22) Filed: Nov. 1, 2013

(51) Int. Cl. H04R 1/10

(52) U.S. Cl. CPC H04R 1/1091
USPC 381/74

(57) ABSTRACT

A light emitting earphone structure comprising a controller, a broadcasting line set and a sound source line set, the controller is provided inside of it with at least an LED lamp, the broadcasting line set includes two broadcasting units, and at least two light guiding fibers respectively provided along the broadcasting lines; when a user is listening music, the LED lamp lightens and flashes, and by optically guiding of the guiding fibers, lightening and flashing rise surrounding the broadcasting lines, hence an effect of easily being seen and a warning function and an effect of amusement can be obtained.

### BACKGROUND OF THE INVENTION

1. Field of the Invention

The present invention relates to a light emitting earphone structure, and especially to a light emitting earphone structure which has broadcasting lines provided near by it and can emit light and shine in pace with the altering of acoustic frequency.

2. Description of the Prior Art

A conventional earphone includes a couple of broadcasting units, a connecter of a source of sound connecting with outer signals of the source of sound, and two sound source lines electrically connected between various broadcasting units and the connecter of the source of sound for transmitting signals of the source of sound. The broadcasting units normally are put on ears of a user, and receive the signals of the source of sound from a radio set, a hi-fi, an MP3, a mobile phone or a computer through the sound source lines and the connecter of the source of sound, in order that the user can hear voices, music or sound effects put out of the electronic equipments via the broadcasting units.

Moreover, for the expedience of the user in controlling the volume and in selection the songs for listening, a conventional earphone further has a control unit electrically connected with the sound source lines for receiving the signals of the source of sound, hence the user can speedily adjust the volume and select the songs for listening without operating an electronic equipment.

Furthermore, the above mentioned electronic equipments have been widely used, and especially that smart phones have had quite many functions including communication, voice and music broadcasting, they had been a kind of indispensable outfits very long time ago, more and more people know to have the smart phones used together with earphones in order to have their hands freed to do other activities.

However, conventional earphones only with the function of broadcasting are unable satisfied for the need of youths chasing fashion, when in using the earphones to listen voices, music or sound effects, people are hard to notice the sounds in surrounding environments, particularly they are hard to warn the cars driven in such surrounding environments when they are working, moving or exercising in dark circumstances. For example, a user wearing a set of earphones jogging or riding bicycle at night, he is unable to have the drivers in cars remote from him to notice his moving position, and thereby it is hard to prevent an accident, such problems are eagerly needed to be given up.

In view of the above, the inventor of the present invention developed a light emitting earphone structure based on his study in related fields and professional experience of years, the structure can improve the effect of wearing on and warning function except broadcasting, and thus can overcome the problem of the mono function of the conventional earphones.

### SUMMARY OF THE INVENTION

The object of the present invention is to provide a light emitting earphone structure which can render a user listening music to get a benefit of having two broadcasting lines between a controller and two broadcasting units emitted light and shone in pace with the altering of acoustic frequency with lightening and flashing at the surrounding of the broadcasting lines, thereby people can see them easily and an effect of amusement will be obtained.

To get the above stated object, the light emitting earphone structure includes a controller capable of receiving signals of a source of sound, and a sound source line set and a broadcasting line set respectively electrically connected to the two lateral sides of the controller; wherein:

the controller is provided inside of its outer housing with at least an LED lamp, and a power supplying unit for supplying electric power;

the sound source line set includes a sound source connector for putting in outer signals of the source of sound, and a sound source line for transmitting the signals of the source of sound connected between the sound source connector and the controller;

the broadcasting line set includes two broadcasting units for listening of the user, two broadcasting lines respectively connected between the broadcasting units and the controller for transmitting the signals of the source of sound, and at least two light guiding fibers respectively provided along the broadcasting lines; each broadcasting line and at least a light guiding fiber are enveloped in a flexible or soft light transmission sleeve; and each light guiding fiber has one end been gotten closed to the LED lamp; the controller drives and controls the lightening and flashing of the LED lamp in pace with the altering of acoustic frequency of the signals of the source of the sound, and is optically guided by the light guiding fibers to do lightening and flashing surrounding the broadcasting lines.

With the above structure, when a user puts the two broadcasting units on his ears respectively, and connects the sound source connector outwardly to the putting out end for the signals of the source of the sound of an electronic equipment in order that the controller receives the signals of the source of the sound, the two broadcasting units can broadcast the voices, music or sound effects from the signals of the source of the sound for listening of the user, meanwhile, the LED lamp can do lightening and flashing in pace with the altering of acoustic frequency, further by the light guiding of the two light guiding fibers, the two broadcasting lines respectively connected between the broadcasting units and the controller can do lightening and flashing surrounding the broadcasting lines; thereby people can see them easily and an effect of amusement will be obtained, and the earphone can have an added value accordingly.

The followings further introduce the mode of practicing of the present invention:

In practice, the broadcasting units are ear plugs or ear muffs.

In practice, the outer housing of the controller is further provided with a power supply switch for turning on/off the power supplying unit, in order that a user can make selection whether he wants an LED lamp to do lightening and flashing in pace with the altering of acoustic frequency.

In practice, the power supplying unit is a discardable storage battery or a chargeable storage battery,

In practice, the power supplying unit is a chargeable storage battery, and the outer housing of the controller is further provided with a power supplying connecting hole able to electrically connect with the chargeable storage battery and to connect outwardly with a power supply, the outside power supply puts in power source through the power supplying connecting hole to charge the chargeable storage battery.

In practice, the controller is built therein with a lightening style database which is loaded previously with a plurality of lightening style data.

And in practice, the controller is provided on its outer housing with a lightening style switching button, the controller switches the lightening style of the LED lamp through the lightening style switching button to do lightening and flashing according to the signals of the source of sound, or controls the lightening style of the LED lamp according to plurality of lightening style data.

And in practice, the controller is further provided on its outer housing with a clamp for fixing by the user, in order that the user can wear the controller on a clothes or a back pack.

As compared with the conventional technique, the present invention allows the user to be seen by other surrounding people or cars when he is listening music, hence an effect of easily being seen and a warning function and an effect of amusement can be obtained, additionally, the present invention is structurally simple and tiny by volume, it can thus be conveniently carried and have an effect of safety.

The present invention will be apparent after reading the detailed description of the preferred embodiment thereof in reference to the accompanying drawings.

### BRIEF DESCRIPTION OF THE DRAWINGS

FIG. 1 is a perspective view of the present invention;

FIG. 2 is a partial cut open view of the present invention;

FIG. 3 is a schematic side view of the present invention;

FIG. 4 is a block diagram expressing the structure of the present invention.

### DETAILED DESCRIPTION OF THE PREFERRED EMBODIMENT

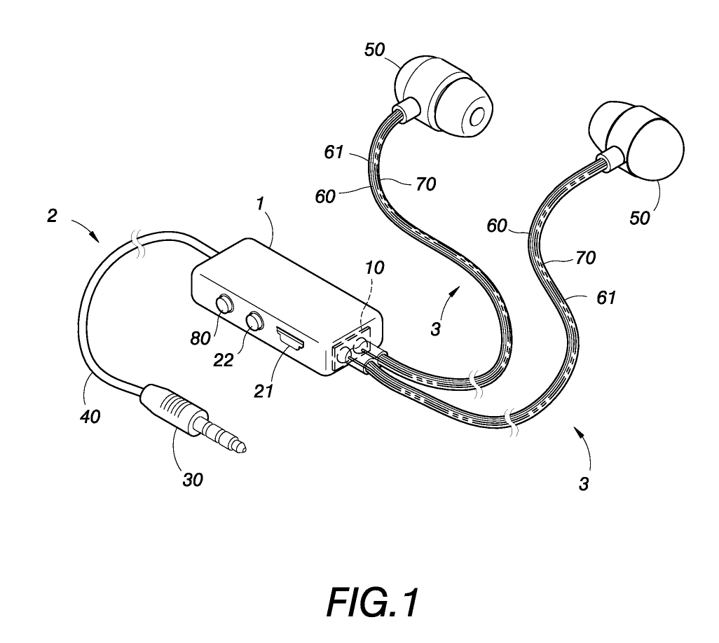

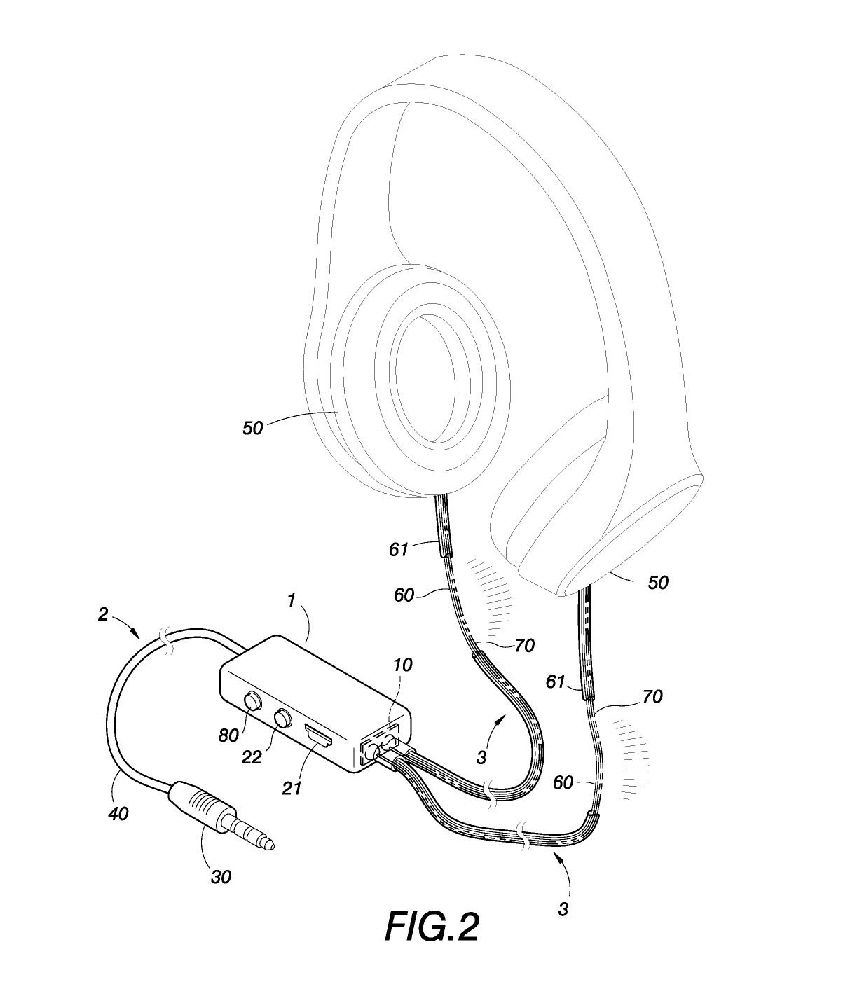

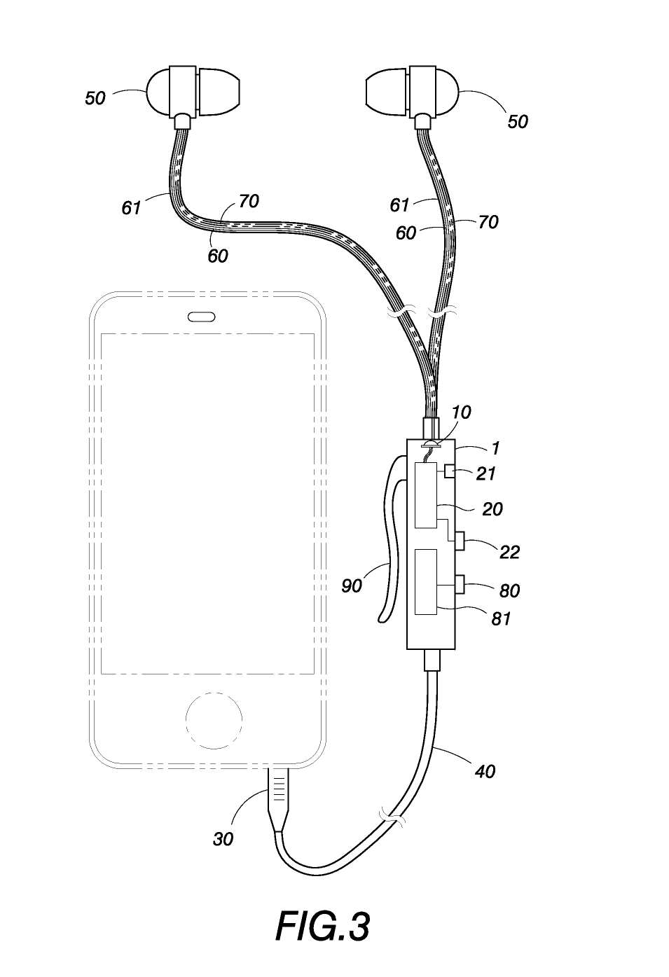

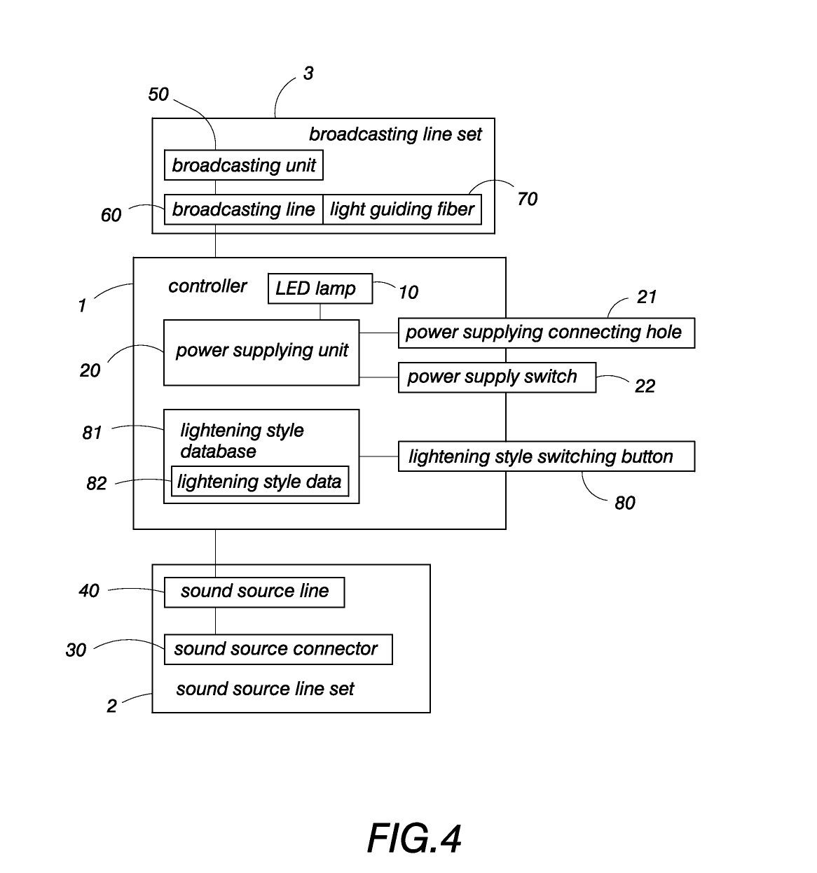

Referring to FIGS. 1 to 4, a light emitting earphone structure of the present invention includes a controller 1 capable of receiving signals of a source of sound, and a sound source line set 2 and a broadcasting line set 3 respectively electrically connected to the two lateral sides of the controller 1; wherein:

the controller 1 is provided inside of its outer housing with at least an LED lamp 10, and a power supplying unit 20 for supplying electric power;

the sound source line set 2 includes a sound source connector 30 for putting in outer signals of the source of sound, and a sound source line 40 for transmitting the signals of the source of sound connected between the sound source connector 30 and the controller 1;

the broadcasting line set 3 includes two broadcasting units 50 for listening of the user, two broadcasting lines 60 respectively connected between the broadcasting units 50 and the controller 1 for transmitting the signals of the source of sound, and at least two light guiding fibers 70 respectively provided along the broadcasting lines 60; each broadcasting line 60 and at least a light guiding fiber 70 are enveloped respectively in a flexible or soft light transmission sleeve 61; and each light guiding fiber 70 has one end been gotten closed to the LED lamp 10; the controller 1 drives and controls the lightening and flashing of the LED lamp 10 in pace with the altering of acoustic frequency and beats of the signals of the source of the sound, and is optically guided by the light guiding fibers 70 to do lightening and flashing surrounding the broadcasting lines 60.

With the above structure, when a user puts the two broadcasting units 50 on his ears respectively, and connects the sound source connector 30 outwardly to the putting out end for the signals of the source of the sound of an electronic equipment in order that the controller 1 receives the signals of the source of the sound, the two broadcasting units 50 can broadcast the voices, music or sound effects from the signals of the source of the sound for listening of the user, meanwhile, the LED lamp 10 can do lightening and flashing in pace with the altering of acoustic frequency, further by the light guiding of the two light guiding fibers 70, the two broadcasting lines 60 respectively connected between the broadcasting units 50 and the controller 1 can do lightening and flashing surrounding the broadcasting lines 60; thereby when the user wears the structure, people can see them easily and an effect of amusement will be obtained, and the earphone can have an added value accordingly.

In practice, the broadcasting units 50 are ear plugs or ear muffs. The light transmission sleeve 61 can be made of the materials of plastic, non-woven fabrics etc.

In practice, the power supplying unit 20 is a discardable storage battery or a chargeable storage battery; in mating with the chargeable storage battery, in practice, the outer housing of the controller 1 is further provided with a power supplying connecting hole 21 to electrically connect with the chargeable storage battery and to connect outwardly with a power supply, the outside power supply puts in power source through the power supplying connecting hole 21 to charge the chargeable storage battery. The power supplying connecting hole 21 is an Mini USB or an Micro USB.

And more, the outer housing of the controller 1 is further provided with a power supply switch 22 for turning on/off the power supplying unit 20, in order that the user can make selection whether he wants an LED lamp 10 to do lightening and flashing in pace with the altering of acoustic frequency. When the power supply switch 22 turns off the power supplying unit 20 in power supplying, or when the power supplying unit 20 exhausts its electric power, the LED lamp 10 stops light emitting, however, the broadcasting units 50 still can broadcast voices, music or sound effects through the signals of the source of sound transmitted by the sound source connector 30, the sound source line 40 and the broadcasting lines 60.

Additionally, the controller 1 is provided on its outer housing with a lightening style switching button 80, the controller 1 is built therein with a lightening style database 81 which is loaded previously with a plurality of lightening style data 82; the controller 1 switches the LED lamp 10 through the lightening style switching button 80 to do lightening and flashing according to the signals of the source of sound, or controls the lightening style of the LED lamp 10 according to different lightening style data 82 such as: lightening brightness, mono color, colors, flashing with fixed frequency or unfixed frequencies, magic lamp style, imitated water flowing style etc.

And in practice, the controller 1 is further provided on its outer housing with a clamp 90 for fixing by the user, in order that the user can wear the controller 1 on a clothes or a back pack.

The above specification and the drawings provided are only for illustrating a preferred embodiment of the present invention, and not forgiving any limitation to the scope of the present invention. It will be apparent to those skilled in this art that various modifications or changes can be made to the elements of the present invention without departing from the spirit and principle of this invention and shall fall within the scope of the appended claims and are intended to form part of this invention.

1. A light emitting earphone structure comprising:
a controller adapted to receiving signals of a source of sound, and a sound source line set and a broadcasting line set respectively electrically connected to two lateral sides of said controller; wherein:
said controller is provided inside of its outer housing with at least an LED lamp, and a power supplying unit for supplying electric power;
said sound source line set includes a sound source connector for putting in outer signals of said source of sound, and a sound source line for transmitting said signals of said source of sound connected between said sound source connector and said controller;
said broadcasting line set includes two broadcasting units for listening of a user, two broadcasting lines respectively connected between said broadcasting units and said controller for transmitting said signals of the source of sound, and at least two light guiding fibers respectively provided along said broadcasting lines; each of said broadcasting lines and at least a light guiding fiber are enveloped in a flexible or soft light transmission sleeve; and each of said light guiding fibers has one end been gotten closed to an LED lamp; said controller drives and controls lightening and flashing of said LED lamp in pace with altering of acoustic frequency of said signals of said source of sound, and is optically guided by said light guiding fibers to do lightening and flashing surrounding said broadcasting lines.

2. The light emitting earphone structure as defined in claim 1, wherein:
said broadcasting units are ear plugs or ear muffs.

3. The light emitting earphone structure as defined in claim 1, wherein:
said outer housing of said controller is further provided with a power supply switch for turning on/off said power supplying unit.

4. The light emitting earphone structure as defined in claim 3, wherein:
said power supplying unit is a discardable storage battery or a chargeable storage battery.

5. The light emitting earphone structure as defined in claim 3, wherein:
said power supplying unit is a chargeable storage battery, and said outer housing of said controller is further provided with a power supplying connecting hole adapted to electrically connect with said chargeable storage battery and to connect outwardly with a power supply, said power supply puts in power source through said power supplying connecting hole to charge said chargeable storage battery.

6. The light emitting earphone structure as defined in claim 1, wherein:
said controller is built therein with a lightening style database which is loaded previously with a plurality of lightening style data.

7. The light emitting earphone structure as defined in claim 6, wherein:
said controller is provided on said outer housing with a lightening style switching button, said controller switches said lightening style of said LED lamp through said lightening style switching button to do lightening and flashing according to said signals of said source of sound, or controls said lightening style of said LED lamp according to different lightening style data.

8. The light emitting earphone structure as defined in claim 1, wherein:
said controller is further provided on said outer housing with a clamp for fixing by a user, in order that said user wears said controller on a clothes or a back pack.
